(19) United States
(12) Patent Application Publication
(10) Pub. No.: US 2009/0246398 A1
(43) Pub. Date: Oct. 1, 2009

(54) METHOD AND APPARATUS FOR FORMING AMORPHOUS COATING FILM

(75) Inventors: Ryurou Kurahashi, Amagasaki-shi (JP); Masahiro Komaki, Sanda-shi (JP); Naoko Nagao, Osaka-shi (JP)

Correspondence Address: OLIFF & BERRIDGE, PLC, P.O. BOX 320850, ALEXANDRIA, VA, 22320-4850, US

(73) Assignee: NAKAYAMA STEEL WORKS ,LTD., OSAKA-SHI, OSAKA-FU (JP)

(21) Appl. No.: 12/310,139

(22) PCT Filed: Aug. 13, 2007
(86) PCT No.: PCT/JP2007/065831

§ 371 Date: Feb. 12, 2009

(30) Foreign Application Priority Data
Aug. 14, 2006 (JP) 2006-221112
Jan. 17, 2007 (JP) 2007-008477

(51) Int. Cl. B05D 1/10; B05C 11/00

(52) U.S. Cl. 427/456; 427/446; 118/47

(57) ABSTRACT

The present invention provides a method and an apparatus for forming, by spraying, a commonly known amorphous coating film, which is not limited to a metallic glass or the like. According to this invention, a flame containing metal particles is ejected toward a base material from a nozzle, such that the material particles are melted with the flame. Thereafter, the melted material particles and flame are cooled before they reach the base material. For this cooling process, a gas is externally ejected toward the flame, such that the gas can gradually approach the central line of the flame. Preferably, the particle size of the material particles in the flame is within a range of 10 to 100 μm.

### CROSS REFERENCE TO RELATED APPLICATIONS

This application is based on the prior Japanese Patent Application Nos. 2006-221112 and 2007-8477, the entire contents of which are incorporated herein by reference.

### TECHNICAL FIELD

The present invention relates to a method and an apparatus for forming an amorphous coating film, by spraying, on a surface of a base material formed from a metal, etc.

### BACKGROUND ART

Generally, an amorphous metal has irregular atomic arrangement different from a crystalline state, exhibits relatively high mechanical strength and corrosion resistance, and is excellent in magnetic properties. Therefore, various studies and developments have been made on a method of manufacturing such a material and use thereof. Besides, various proposals have been offered in regard to a technique for forming the amorphous coating film by spraying a material onto a surface of an object. It will be very advantageous if such an amorphous coating film can be formed by spraying and this formation can be achieved by simple spray equipment as well as by work in the air in any given working site. This is because such formation of the coating film can be readily applied to a considerably wide area. Generally, even if not being in a completely amorphous state, a material partly containing a crystalline portion can also exhibit excellent properties in the mechanical strength and corrosion resistance as well as in magnetic properties.

In JP55-88843A (Patent Document 1), one method of forming the coating film is described, in which an amorphous product is obtained by spraying an alloyed material melted by plasma spraying, together with a flame, toward a base material moved at a relatively high speed in a direction vertical to a spray direction of the sprayed material, then cooling this material on the base material. An apparatus used in this method is of a type as depicted in FIG. 15. Specifically, metal powder is first supplied into a flame F ejected from a nozzle 50, and is melted in the flame. Then, the so-melted metal powder is sprayed toward a base material M. As a result, the so-sprayed metal powder is quenched due to contact with the base material M, as such the amorphous coating film is formed on the base material M. Additionally, a cooling gas is applied onto the base material M in order to cool a surface thereof. In this way, according to this document, an amorphous layer having a thickness of 0.3 mm or more can be obtained on the surface of the base material M having a flat shape as shown in the drawing.

In JP55-88927A (Patent Document 2), one method of forming a metal coating film is described, in which an amorphous alloy is obtained by spraying the alloyed material melted by plasma spraying or the like, together with the flame, toward the base material rotated at a high speed, then cooling this material on the base material. The apparatus used in this method is of a type as shown in FIG. 16. Specifically, the metal powder is first supplied into the flame F ejected from the nozzle 50, and is melted in the flame. Then, the so-melted metal powder is sprayed onto the base material M. As a result, the so-sprayed metal powder is quenched due to contact with the base material M. Thus, the amorphous coating film can be formed on the base material M. In the drawing, reference numeral 90 designates a cooling nozzle for ejecting the cooling gas toward the material. According to this Patent Document 2, if a round bar is used as the base material M as shown in FIG. 16, the amorphous alloy having a seamless-pipe-like shape can be obtained on the surface of such a base material.

In JP2006-214000A (Patent Document 3), one technique for forming a metallic glass layer on the surface of the base material is disclosed. Most of highly corrosion-resistant Fe—P—C type amorphous alloys developed in the 1960s have a quite narrow supercooled-liquid-temperature range. Therefore, if not quenched at a considerably high cooling speed, such as 10⁵K/s or so, by the so-called single roll method or the like, such amorphous alloys cannot be successfully formed. Besides, even though such a quenching method is employed, only a thin ribbon-like alloy having a thickness of approximately 50 μm or less can be produced. To address such inconvenience, a new alloy having a relatively wide supercooled-liquid-temperature range has been found in recent years. Namely, this alloy material can be solidified into a glass layer (or amorphous phase), through the supercooled liquid state, even though cooled at a low speed, such as 0.1 to 100K/s or so, after melted. Such a material is referred to as a metallic glass or glass alloy, and is discriminated from the amorphous alloys commonly known. The Patent Document 3 describes a method and its performance for forming such a metallic glass that can be cooled at a relatively low speed and exhibit a stable supercooled liquid state.

Generally, in order to obtain the amorphous metal or the like material by spraying the melted material, together with the flame, toward the base material, it is necessary to cool the sprayed material, at a very high cooling speed, once the material was melted by the flame. Namely, it is necessary to cool the sprayed material, in a relatively short time, such that the material can be changed into a desired supercooled state.

Actually, however, it is rather difficult to cool the sprayed material so rapidly that a desired amorphous phase can be adequately created. For instance, the material, in a high temperature state exceeding. 2000° C., as usually seen immediately after it is sprayed together with the flame, can be cooled at a relatively high speed of 10⁴K/s or higher. However, after the temperature of the material is lowered to approximately several hundred degrees, it is generally difficult to achieve such a higher cooling speed, and is also difficult to further lower enough the ultimate lowest temperature. This is because, for example, the temperature difference relative to the environment is considerably reduced. Accordingly, as described in the Patent Document 3, it is generally difficult to obtain a commonly known amorphous metal (other than the metallic glass) having a desired amorphous state. Therefore, there has been so far no spray method well established for industrial mass-production of such an amorphous metal.

### DISCLOSURE OF THE INVENTION

The present invention provides a method and an apparatus for forming, by spraying, an amorphous coating film (or mostly amorphous coating film) of a commonly known amorphous material that is not limited to the metallic glass or the like.

The method and apparatus for forming the amorphous coating film by spraying, according to the present invention, are respectively constituted for ejecting a flame containing material particles toward a base material from a nozzle, such that the material particles are melted with the flame, and cooling the material particles and flame before they reach the base material. As used herein, the term “flame” includes an arc or plasma jet. Additionally, the term “amorphous coating film” is used to imply an amorphous metal, a nonmetal as well as a material not completely changed into an amorphous state.

According to the method and apparatus of this invention, the sprayed material particles and flame can be positively cooled. Therefore, the temperature of the material particles once melted with the flame is considerably lowered in a downstream portion, etc., of the flame before the material particles reach the base material. Accordingly, the material particles can be cooled sufficiently, even in such a downstream region (or relatively lowered temperature region) in which an adequate cooling speed and a desired ultimate lowest temperature cannot be usually achieved for the reason as described above. As such, the material particles can be changed into a desired amorphous coating film formed on a surface of the base material, even if the temperature of the base material itself is not positively lowered or controlled.

Preferably, the cooling of the flame containing the material particles is performed by externally ejecting a cooling fluid, consisting of a gas or a gas mixed with a liquid mist, toward the flame. As used herein, the term “gas mixed with a liquid mist” means a mixture of the gas with a liquid changed into a mist. Preferably, a cooling gas is ejected from a gas ejection cylinder of a spray gun toward the flame in order to cool the flame, in addition to the cooling fluid externally ejected toward the flame.

As the gas used for cooling the flame, for example, air, nitrogen, argon or the like can be used. Preferably, the cooling fluid is obliquely ejected from the nozzle toward a central line of the flame, such that the cooling fluid gradually approaches the central line of the flame as the cooling fluid travels from an upstream side to a downstream side along an ejection direction of the flame.

Such an ejecting manner of the cooling fluid and/or gas toward the flame can positively lower the temperature of the flame, while narrowing and shortening a region or space occupied by the flame. As such, the temperature of the flame can be lowered enough, even in a position not so far from an ejection port thereof. Such lowering of the temperature of the flame in the vicinity of the ejection port successfully serves to quench the material once melted in the flame. In addition, if the cooling fluid and/or gas are also applied at a point nearer to the downstream portion of the flame, the cooling speed of the material particles can be effectively elevated, even after the temperature thereof is lowered to some extent. Preferably, the cooling fluid and/or gas are ejected toward the flame from a plurality of points positioned along and around the flame. In this case, if the gas containing the mist (e.g., a water mist) is used, higher cooling ability can be achieved due to the heat of vaporization of fine liquid particles (approximately 50 μm) constituting the mist. Consequently, the temperature of the sprayed material when attached to the base material can be lowered up to about 150° C.

Preferably, the temperature of the base material is controlled within a range of 50° C. to 350° C., while the base material is not cooled by any other special temperature control than the cooling due to the cooling fluid consisting of the gas or gas mixed with the liquid mist.

In this way, temperature rising of the base material can be sufficiently suppressed, by only an effect of the cooling fluid and/or gas applied to the base material, without depending on any other cooling means, so that the sprayed material will be likely to be attached to the surface of the base material.

Preferably, the material particles are melted within 5/1000 seconds after ejected from the nozzle, and then cooled within 2/1000 seconds at a cooling speed within a range of 10,000K/sec to 1,000,000K/sec.

If the material particles are not melted within 5/1000 seconds after ejected from the nozzle, such particles would reach the base material still in a solid state (or in a state in which only the surface of each particle is melted), thus being less likely to be changed into a sufficiently uniformed amorphous coating film. Additionally, if the material particles are not cooled within 2/1000 seconds at the cooling speed within the range of 10,000K/sec to 1,000,000K/sec (or several million K/sec), such particles would not be amorphous. Namely, in such a case, the material particles cannot be cooled sufficiently before reaching the base material positioned at a proper distance (e.g., approximately 300 mm or less) from the nozzle. For instance, if the base material is positioned farther than such a proper distance, oxidation of the particles may tend to be unduly progressed because of increase of oxygen in the flame.

Assuming that each material particle is substantially spherical, the particle size (R) of the material particles is preferably expressed by the following expression (1):

R=(6U)/{ρ·C·(v/v₀)^{1/2}} (1)

wherein U designates an amount of heat per unit surface area and is expressed as follows:

U=(the amount of heat (cal/° C.) of each material particle)/(the surface area of the material particle (cm²))=C·ρ·V/A (cal/cm²° C.),

0.196/1000≦U≦1.96/1000, and

wherein V is a volume (cm³) of the material particle, A is the surface area (cm²) of the material particle, ρ is a specific gravity (g/cm³) of the material, C is specific heat (cal/g° C.) of the material, v is a speed (cm/sec) of the material particle when it is ejected, and v₀ is a standard material-particle speed (6000 cm/sec).

If a value of U is within the range described above, the particle size R can be set within a suitable range that enables the amorphous coating film to be formed by spraying.

In order to stably form the amorphous coating film by spraying, it is necessary to properly set the particle size of the material particles that will be sprayed. Namely, if the particle size is too large, the material particles may tend to be incompletely melted and/or the cooling speed after the particles are melted is likely to be insufficient. Contrary, if the particle size is unduly small, excessive oxidation of the melted material particles may badly affect the formation of a desired amorphous coating film.

The above expression (1) is provided herein to set the proper range of the particle size R of the material particles, based on the following results (1) to (3) of our experiments as well as on the so-called Newton's cooling theory or expression.

(1) A shape of each material particle during a travel after ejected from the nozzle was confirmed by our experiment of spraying the material particles toward agar. Results of this experiment are shown in FIGS. 9(a) and 9(b), respectively. In this case, the agar (containing 1.7 wt % of agar component and the remainder water) was located in a position (e.g., about 200 mm ahead from the nozzle) in which the base material would be otherwise located in an actual process. Then, the flame containing the material particles was sprayed toward the agar. As a result, each material particle was stuck into the agar while keeping its shape during the travel. Thereafter, when we collected such material particles from the agar and observed the shape of each particle, it was found that each material particle during the travel maintained a spherical shape of an initial powder material thereof before sprayed. Therefore, the volume and surface area (which will be described later) of each powder material could be calculated, based on such an experimentally observed spherical shape thereof, thus facilitating application of the Newton's cooling equation to this case.
(2) The speed of the material particles after ejected was measured. Results of this measurement are shown in FIG. 7. Specifically, the speed was measured by using a Pitot-tube-type current meter, with pressure of the air used for the external cooling being changed.
(3) The temperature of the flame was measured by using a thermal vision. Results of this measurement are shown in FIG. 3.

Then, based on data of the above experiments as well as on the Newton's cooling equation as expressed by the following expression (2), the cooling speed of the material particles was estimated. Namely, assuming that a transfer amount of heat per unit time is expressed by q(cal/sec), the expression (2) can be expressed as follows:

q=hA(T−T∞)=−CρV(dT/dt) (2)

wherein T=T₀ (initial material temperature) when the time t is 0,

wherein (T−T∞)/(T₀−T∞)=expₑ{−(hA/CρV)t}, and

wherein h is a heat transfer coefficient (cal/cm²·K·sec), T is a material particle temperature (K), T∞ is an ambient temperature (K), A is the surface area (cm²), V is the volume (cm³), ρ is the specific gravity (g/cm³, based on a weight ratio of each component), and C is the average specific heat (cal/g·K, also based on the weight ratio of each component).

Further, each temperature change was calculated, with respect to particular material particles, as will be described later, under particular conditions, with the heat transfer coefficient h determined to be matched with the data of actual measurements as shown in FIG. 3 and the like. Results of this calculation are shown in FIG. 8. Referring to this drawing, it can be seen that about ¾ of the spray time (before the material particles reaches the base material after they are ejected) is spent for heating the material particles, while about ¼ of the spray time is spent for cooling the material particles, due to a higher cooling speed, such as 10⁴ to 10⁶K/s. It can also be seen that the heating speed and/or cooling speed will vary with the particle size (e.g., 38 μm, 63 μm) of the material particles.

Namely, we provided herein the above expression (1) intended for determining the suitable particle size R for the material particles, while taking into account relations between the particle size in the above calculation results and the heating and cooling speeds, as well as considering the following points. For instance, the heating speed and/or cooling speed will differ, depending on physical properties of the material particles (i.e., the specific gravity, specific heat and the like). In addition, the influence on the material particles due to the spray temperature will vary with the surface area of each material particle. Accordingly, we concluded that the temperature rising and/or temperature lowering of the material particles can be determined, based on the amount of heat per unit surface area (U) of each material particle as expressed by the following expression:

U=(the amount of heat of each material particle)/(the surface area of the material particle)=C·ρ·V/A (cal/cm²° C.),

wherein C is the specific heat (cal/g° C.) of the material, ρ is the specific gravity (g/cm³) of the material, A is the surface area (cm², 4πr²) of the material, and V is the volume of the material (cm³, 4πr³/3).

Thus, in view of quality of the amorphous coating film actually formed, we determined an applicable range of the value U to be within the following range:

0.196/1000≦U≦1.96/1000.

Viewing an influence, on the spray speed of the material when sprayed, due to a kind of each spray gun, the above expression is corrected by the following correction term for the speed:

(v/v₀)^{1/2},

wherein v is a speed of the material particle during the spraying process (cm/sec), and

wherein v₀ is a standard material particle speed (6000 cm/sec).

Accordingly, the particle size R (=2 r) can be expressed as follows, by substituting A=4πr², V=4πr³/3 into the above expression of U, respectively, then changing the expression with respect to R.

R=(6U)/{p·C·(v/v₀)^{1/2}} (1)

Preferably, the material particles having the particle size R within a range of 10 to 100 μm are used, in the case of using a flame-type spray gun of an average particle speed of, for example, 60 m/s.

However, in the case of using a High Velocity Oxy-Fuel spray gun of a spray speed of 600 m/s, the particle size R that enables the amorphous coating film to be formed by spraying will be within a range of 3.2 to 32 μm.

Preferably, a reducing flame containing 20 to 30% by volume (or v/v) of CO, while containing oxygen less than a theoretical amount of the oxygen contained in a normal flame, is used as the flame. However, this does not apply to the case in which hydrogen is used as a fuel gas.

In the case of observing each amorphous coating film formed on the base material, by using a microscope, it was sometimes found that oxides were undesirably interspersed at many points in the coating film, even when a halo peak and crystallinity were of an equal level between the observed coating films. As is seen from the above discussion, such occurrence of the oxides can be prevented by controlling the particle size of the material particles not to be unduly small. However, by our experiments, it was demonstrated that such occurrence of the oxides can also be prevented by using a proper reducing flame in the flame-type spray apparatus. Especially, the use of such a reducing flame is effective, in the case in which the particle size of the material particles is relatively small and/or case in which the distance from the spray port for the flame and the like to the base material is relatively long.

Results of the above experiments are shown in Table 2 and FIGS. 10 and 11. Namely, by using such a reducing flame, a desired amorphous coating film, containing significantly fewer oxides, can be formed, with the halo peak and/or crystallinity being kept at an equal level.

Preferably, an inert gas (e.g., nitrogen, argon or the like) is used, as the gas or gas mixed with the liquid mist sprayed toward the flame.

By our experiments, it was found that an excellent amorphous coating film can also be formed by ejecting such an inert gas as the cooling fluid toward the flame, in order to suppress oxidation of the material particles. Results of these experiments are also shown in Table 2, FIGS. 10 and 11. Usually, the oxidation of the material particles is likely to be progressed, in the case in which the particle size of the material particles is relatively small and/or case in which the distance from the ejection port for the flame, etc., to the base material is relatively long. Therefore, the use of the inert gas as describe above is effective in particular for such cases.

It is commercially advantageous that a material used for general industrial purposes and containing impurities (e.g., Mn, S or the like) within a range of from 0.1% to 0.6% by weight (of the total weight of the material) can be used as the material particles.

According to the method of this invention, the amorphous coating film can be formed on the surface of the base material, without using such highly purified material particles as those containing the impurities less than 0.1%. Namely, with this invention, the amorphous coating film can be formed, even in the case of using the material used for general industrial purposes and containing the impurities within the range of from approximately 0.1% to 0.6%. This is highly advantageous for the production cost.

More preferably, the spray gun including the nozzle is used in the air for spraying the material particles onto the surface of the base material, while a rear face and an interior of the base material is not cooled.

According to this invention, there is no need for using the highly purified material particles containing the impurities less than 0.1%, as well as no need for using the spray gun in a vacuum environment or under a special atmosphere and/or cooling the rear face and interior of the base material. Namely, this invention enables the amorphous coating film to be formed on the surface of the base material, without requiring such special conditions. Namely, the method of forming the amorphous coating film according to this invention, which uses the material used for general industrial purposes and containing the impurities within the range of from approximately 0.1% to 0.6%, allows the spray gun to be used in the air and requires no special cooling means for the base material, can be performed with ease, in any given working site, at a lower cost, for any suitable base material. This can provide a variety of applications to the method of manufacturing the amorphous coating film.

Preferably, a Fe(r1)-Cr(r2)-P(r3)-C(r4)-impurity type material is used as the material particles, for forming the amorphous coating film of an iron-chromium type alloy,

wherein each ri of r1 to r4 designates an atomic percentage (%), and satisfies the following expression:

Σri=r1+r2+r3+r4≈100(%), in which

65<r1<75, 4<r2<15, 8<r3<17, 1<r4<8, and

wherein the content of the impurities is within a range of 0.1 to 0.6 wt %.

Although the amorphous coating film of such an iron-chromium type alloy has been known to have excellent corrosion resistance, it has been difficult to manufacture such a coating film for industrial purposes. However, the method according to the present invention enables such an amorphous coating film to be formed. As such, the corrosion resistance of the base material can be highly enhanced by a significantly simplified spraying work.

More preferably, r1, r2, r3, r4 in the above expression are 70, 10, 13, 7, respectively.

In this way, the amorphous coating film of the iron-chromium type alloy (Fe₇₀Cr₁₀P₁₃C₇), which is known to have excellent corrosion resistance, can be formed on the base material by spraying. Thus, the corrosion resistance of the base material can be highly enhanced. In our corrosion test of immersing the coating film formed from this alloy material by the aforementioned method, into aqua regia, significantly excellent corrosion resistance was confirmed as shown in FIG. 12 (i.e., a rate of progress of corrosion was 1.2%/day).

Preferably, the material particles, in which r1, r2, r3, r4 in the above expression are 70, 10, 13, 7, respectively, has a particle size within a range of 38 μm to 63 μm. Our experiments demonstrated that such a range of the particles size was suitable for forming the amorphous coating film.

By substituting each value of the above physical properties of the material particles into the expression (1) described above, the value of U can be obtained as follows.

0.75/1000≦U≦1.23/1000

Preferably, a Fe(r1)-B(r2)-Si(r3)-C(r4)-impurity type material is used as the material particles, for forming the amorphous coating film of a magnetic alloy,

wherein each ri of r1 to r4 designates an atomic percentage (%), and satisfies the following expression:

Σri=r1+r2+r3+r4≈100, in which

2<r1<85, 11<r2<16, 3<r3<12, 1<r4<72, and

wherein the content of the impurities is 0.6 wt % or less (with a lower limit of, for example, 0.003 wt %).

By using such material particles, a highly desired amorphous coating film of a magnetic alloy can be formed on the surface of the base material, wherein the resultant coating film will exhibit excellent magnetic properties in any direction, with less iron loss.

More preferably, r1, r2, r3, r4 in the above expression are 81, 13, 4, 2, respectively, wherein the content of the impurities is 0.6 wt % or less (with a lower limit of, for example, 0.003 wt %).

By using such material particles, the amorphous coating film of the magnetic alloy (Fe₈₀B₁₃Si₄C₂), which can exhibit excellent magnetic properties in any direction, can be formed on the base material by spraying. Results of our experiments for this coating material are shown in FIG. 14.

According to the method and apparatus of this invention for forming the amorphous coating film by spraying, both of the sprayed material particles and flame can be positively and sufficiently cooled, as such the material particles can be successfully changed into the amorphous coating film formed on the surface of the base material.

The cooling of the material particles and flame can be achieved by ejecting the gas, etc., toward the flame. In this case, a rate of changing the material into the amorphous state and control of occurrence of the oxides can be further improved, by properly setting or selecting the kind of each gas, manner of ejecting the gas, particle size of the material particles, components of the flame and the like. Additionally, in the method of this invention, the material particles of relatively low purity can also be used as the spray material. This can significantly reduce the production cost, thus being commercially advantageous.

In the case of forming the amorphous coating film of the iron-chromium-type alloy, especially in the case of forming the coating film of the Fe₇₀Cr₁₀P₁₃C₇ alloy, on the base material, the corrosion resistance of the base material can be dramatically enhanced by a significantly simplified spraying work. Alternatively, the amorphous coating film of the magnetic alloy can also be formed on the base material.

### BRIEF DESCRIPTION OF DRAWINGS

FIGS. 1(a) and 1(b) respectively illustrate a spray apparatus 1 used in one embodiment of the present invention, wherein FIG. 1(a) shows a general construction of the spray apparatus 1, and FIG. 1(b) is a graph showing distribution of flame temperature in the spray apparatus 1.

FIGS. 2(a) and 2(b) are respectively illustrate a structure of a spray gun 2 of the spray apparatus 1, wherein FIG. 2(a) shows a general construction of the spray gun 2, and FIG. 2(b) shows details of a part b (or distal end) of the spray gun 2.

FIGS. 3(a), 3(b) and 3(c) respectively show a state of a flame during a spray process related to the spray apparatus 1 of this embodiment, wherein FIGS. 3(a) and 3(b) are charts respectively showing a temperature change of the flame along a central line thereof. More specifically, FIG. 3(a) shows a higher temperature portion, while FIG. 3(b) shows a lower temperature portion. FIG. 3(c) shows temperature distribution of the flame obtained by a thermal vision.

FIG. 4 shows a result of a temperature measurement for a base material M, obtained by using a thermocouple attached to a surface of the base material M.

FIG. 5 shows results of measurements ((a) to (f)) for the temperature distribution of the flame, obtained by using the thermal vision, wherein pressure of air (or external gas) externally ejected toward the flame is changed.

FIGS. 6(a) to 6(f) show results of X-ray diffraction measurements for the coating films each formed on the base material in the cases shown in FIGS. 5(a) to 5(f), respectively.

FIG. 7 shows a result of a measurement for a speed of the flame in each portion thereof, wherein the pressure of the air used as the external gas is changed.

FIG. 8 is a chart showing a temperature change of metal particles in the flame.

FIG. 9(a) is a photograph of a section, for illustrating one aspect of capturing the metal particles in the flame in a test, and FIG. 9(b) is an SEM photograph of the captured particles.

FIGS. 10(a) to 10(e) are microphotographs (left: ×400, right: ×1000), each showing a section of a sprayed coating film, wherein a diameter of each metal particle and a kind of each external gas are changed, respectively.

FIGS. 11(a) to 11(e) show results of the X-ray diffraction measurements for the sprayed coating films used in the cases shown in FIGS. 10(a) to 10(e), respectively.

FIG. 12 shows a result of a corrosion-resistance test using aqua regia, for the sprayed coating film of a Fe₇₀Cr₁₀P₁₃C₇ alloy formed by the method of this embodiment as well as a result of the same test for stainless steel (SUS316L).

FIG. 13 shows a result of a heat-resistance test on the sprayed coating film formed by the method of this embodiment.

FIG. 14 shows a result of the X-ray diffraction measurements for the sprayed coating film of a Fe₈₁B₁₃Si₄C₂ alloy formed by the method of this embodiment.

FIG. 15 is a section illustrating one example of a conventional spray method described in Patent Document 1 (JP55-88843A).

FIG. 16 is a section illustrating another example of the conventional spray method described in Patent Document 2 (JP55-88927A).

### BEST MODE FOR CARRYING OUT THE INVENTION

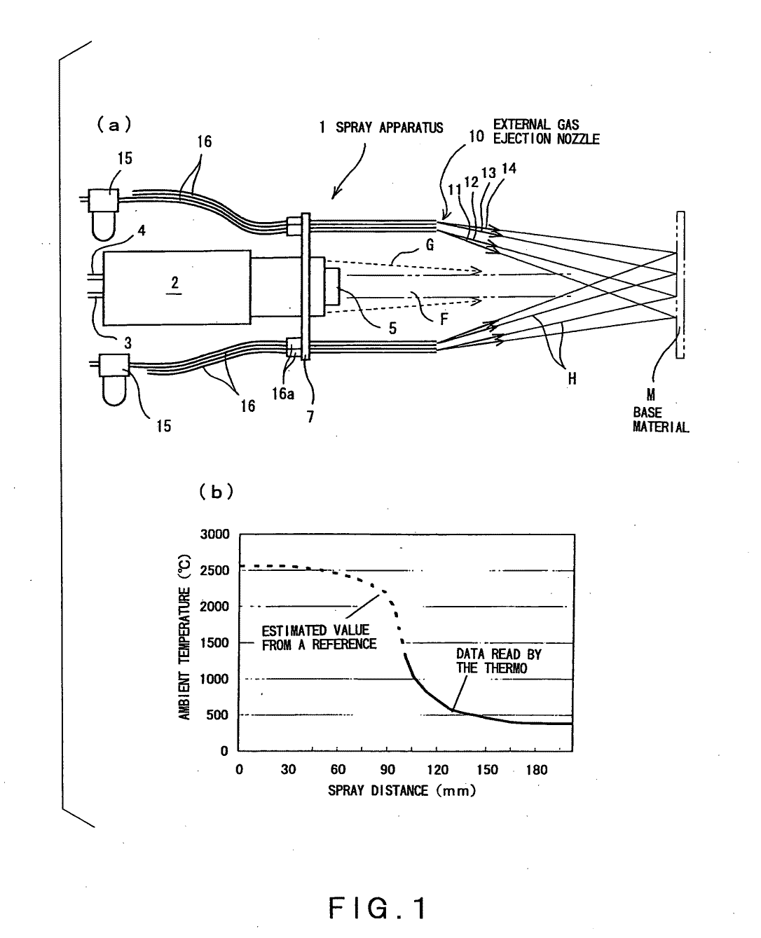

Hereinafter, one embodiment of the present invention will be described, with reference to FIGS. 1 to 14.

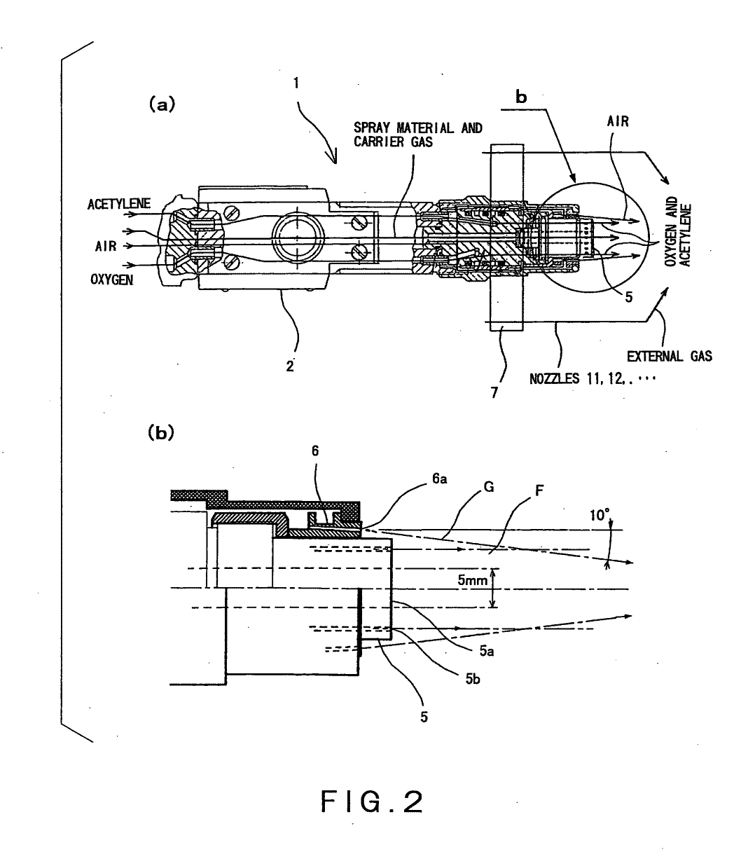

Referring first to FIGS. 1 and 2, construction of a spray apparatus 1 will be described. The spray apparatus 1 is based on a commercially available spray gun 2, and is configured for supplying fuel (acetylene and oxygen) from a gas supply pipe 3 as well as for supplying metal powder and a carrier gas from a powder supply pipe 4, to the spray gun 2. Thus, the spray apparatus 1 can eject a flame F containing a spray material (formed from the supplied and melted metal powder), in a right direction in the drawings, from a main nozzle (or burner) 5 of the spray gun 2. In the main nozzle 5, the spray material is sprayed from an ejection port 5a located at a central portion as shown in FIG. 2(b), while the flame F formed from a burned mixed gas of acetylene and oxygen (or air) is ejected from a plurality of ejection ports 5b located around the ejection port 5a.

The spray apparatus 1 used in this embodiment includes modifications, (a) to (c), as will be described below, respectively added to the commercially available spray gun 2.

(a) A support frame 7 is provided around a distal end portion of the spray gun 2, and a plurality of external gas ejection nozzles (cooling fluid ejection nozzles) 10 (11, 12, 13, 14) are attached to the support frame 7 as shown in FIG. 1(a). Each nozzle 10 is formed of a metallic pipe having an inner diameter of approximately 5 to 10 mm, and extends outside the main nozzle 5 of the spray gun 2, substantially parallel to an ejection direction of the flame F, from a base portion of the nozzle 10 attached to the support frame 7. As shown in the drawing, a distal end of each nozzle 10 is inclined toward a central line of the flame F. The nozzles 10 include primary nozzles 11, secondary nozzles 12, tertiary nozzles 13 and quaternary nozzles 14, respectively having distal ends inclined at different angles. Specifically, the distal end (or distal ejection opening) of each primary nozzle 11 is provided in a position approximately 60 mm downstream from the main nozzle 5, and is inclined toward a center of the flame F further 20 to 30 mm downstream from the position in which the distal end of the primary nozzle 11 is provided. Each of the other gas ejection nozzles 12, 13 and 14 has a distal end inclined toward a further downstream center of the flame F, in this order. With such configuration, a cooling fluid (or gas) H (i.e., the external gas, e.g., air, nitrogen and/or water mist) can be externally ejected toward a downstream portion (or region of an approximately latter half of a distance from the main nozzle 5 to a base material M) of the flame F. Preferably, the primary to quaternary nozzles 11 to 14 of the nozzles 10, are respectively shifted in a longitudinal direction of the flame F. Preferably, these nozzles 11 to 14 are respectively provided, in a plural number, along and around the flame F, with an interval of 45° to 72°. The base portion of each nozzle 10 attached to the support frame 7 is in communication with a joint 16a provided to a rear side (opposite side in the ejection direction of the flame F) of the support frame 7, and is connected with a flexible hose 16 via the joint 16a. It is noted that the support frame 7 is temporarily provided for an experiment, and that each nozzle 10 may be used without such a support frame 7. It is also noted that the length of each nozzle 10 (11, 12, 13, 14), position and angle of the distal end thereof, ejecting pressure and amount of each gas, and the like may be suitably changed, corresponding to cooling conditions or the like.
(b) A mist generator 15 is connected with an upstream end of each external gas ejection nozzle 10 (11 to 14) via the flexible hose 16. As the mist generator 15, a commercially available oil mist generator (or lubricator), generally used for supplying lubricating oil, can be mentioned. By supplying water in place of the lubricating oil into a liquid feeding part, the Water can be fed into each nozzle 10, in an atomized or water-mist state, together with the air. In this way, the spray apparatus 1 can spray the water mist toward the flame F from the distal end of each nozzle 10. If no liquid is supplied into the mist generator 15, only the air (or any other suitable gas, such as nitrogen or the like) not containing any mist can be sprayed from each nozzle 10. It should be appreciated that a means for spraying the water mist is not limited to the one described above.
(c) As the spray gun 2, one type as shown in FIGS. 2(a) and 2(b) can be employed. Specifically, the gun 2 of this type has a gas ejection cylinder (air cap) 6, which is provided around the main nozzle 5 for ejecting the flame F toward an object. With such configuration, a cooling gas (e.g., air G of a normal temperature) can be ejected for the purpose of cooling a main body of the spray gun 2, controlling the temperature of the flame F, ect. In this spray apparatus 1, an ejection port 6a of the ejection cylinder 6 is modified to have a particular angle for an ejection direction of the gas, while a caliber of the ejection port 5a for the spray material in the main nozzle 5 is set larger than the commercially available one. For instance, as the ejection angle of the cooling gas, an angle of 10° (or 9 to 12°) is set relative to the central line of the flame F, as shown in the drawing, such that the ejected cooling gas can gradually approach the central line of the flame F from the outside. Meanwhile, the caliber (or diameter) of the ejection port 5a of the main nozzle 5 is set at 5.0 mm (or 4 to 6 mm), which is larger, by approximately 60%, than the commercially available one (having a 3.0 mm caliber). This enlargement of the caliber of the ejection port 5a is intended for spraying the spray material in a greater amount at a higher temperature. The setting of the ejection angle of the cooling gas at 10° relative to the central line of the flame F is aimed at cooling the flame F, by using the air G ejected from the ejection cylinder 6, in a relatively upstream portion of the flame F (or in a position near the main nozzle 5), as well as aimed at narrowing and shortening a region occupied by the flame F. For discrimination, the cooling of the flame F by using each external gas ejection nozzle 10 will be referred to as the “external cooling”, while the cooling due to the gas (or air G) ejected from the gas ejection cylinder 6 will be referred to as the “internal cooling”.

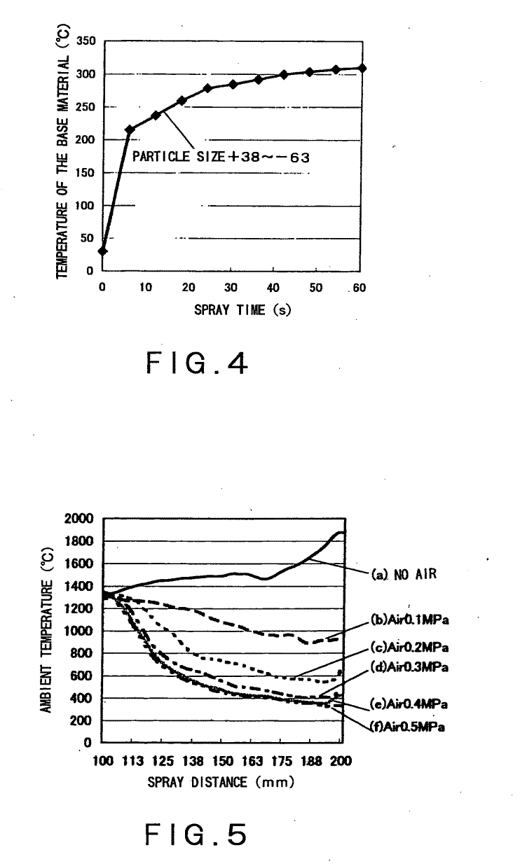

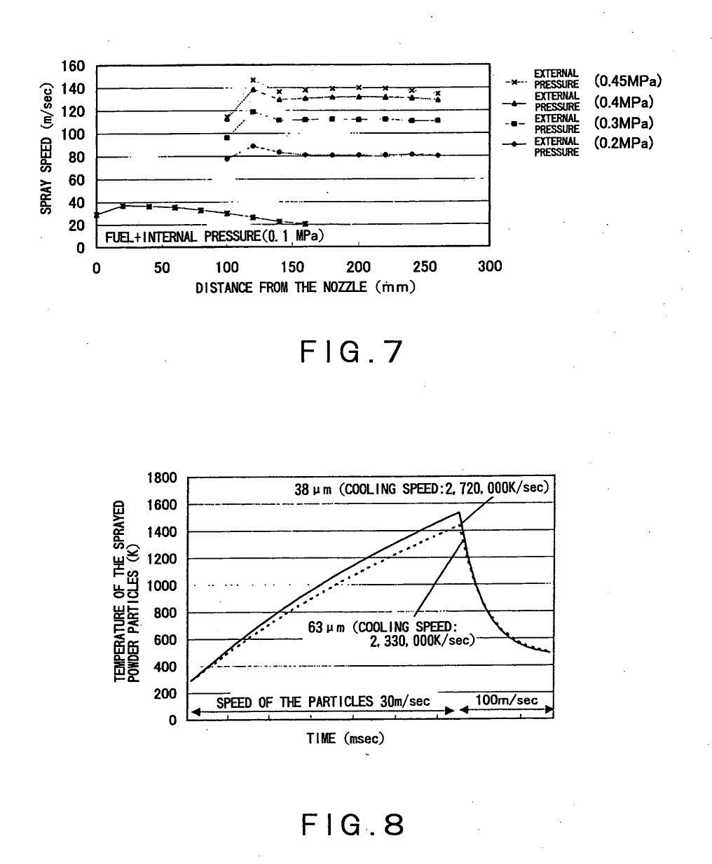

With such a modified spray apparatus 1 as shown in FIGS. 1 and 2, the temperature of the flame F (containing the spray material) ejected from the main nozzle 5 is changed, over a spray distance, for example, as shown in FIG. 1(b). Namely, because the caliber of the ejection port 5a is set larger than usual, the temperature of the flame F is relatively high (about 2500° C.) immediately after the flame F is ejected from the main nozzle 5. However, the temperature is lowered to about 1400° in approximately the first half of the total spray distance. Meanwhile, a flying or traveling speed of the metal powder at about 3/1000 seconds after it is ejected from the main nozzle 5 is approximately 30 m/second (see FIG. 7), and the metal power is completely melted during this period. In the latter half of the total spray distance, the external cooling due to the external gas ejection nozzles 10 begins, thus the metal powder in a melted state is accelerated up to approximately 100 m/second by the gas (or mist containing gas) ejected from the nozzles (see FIG. 7). The cooling during the travel over the latter half distance is carried out at a speed of 10⁴ to 10⁶K/second, and the metal powder that has been so far in a melted state is then stuck onto a surface of the base material M while being rapidly cooled. In this manner, the metal powder is changed into an amorphous coating. During this formation of the coating film, the temperature of the base material M is kept around 300° C. (within a range of 50° C. to 350° C.) as shown in FIG. 4.

In a test using the spray apparatus 1 having such features as described above, the amorphous coating film (or mostly amorphous coating film) was prepared by spraying each selected material onto a surface of an iron plate. In this test, as shown in FIG. 1(a), the base material M formed of an iron plate was placed at a distance of approximately 150 to 200 mm from the distal opening of the main nozzle 5, and a spray process was then carried out, with each kind of metal powder being supplied as the spray material. Hereinafter, each of our tests and results thereof will be discussed.

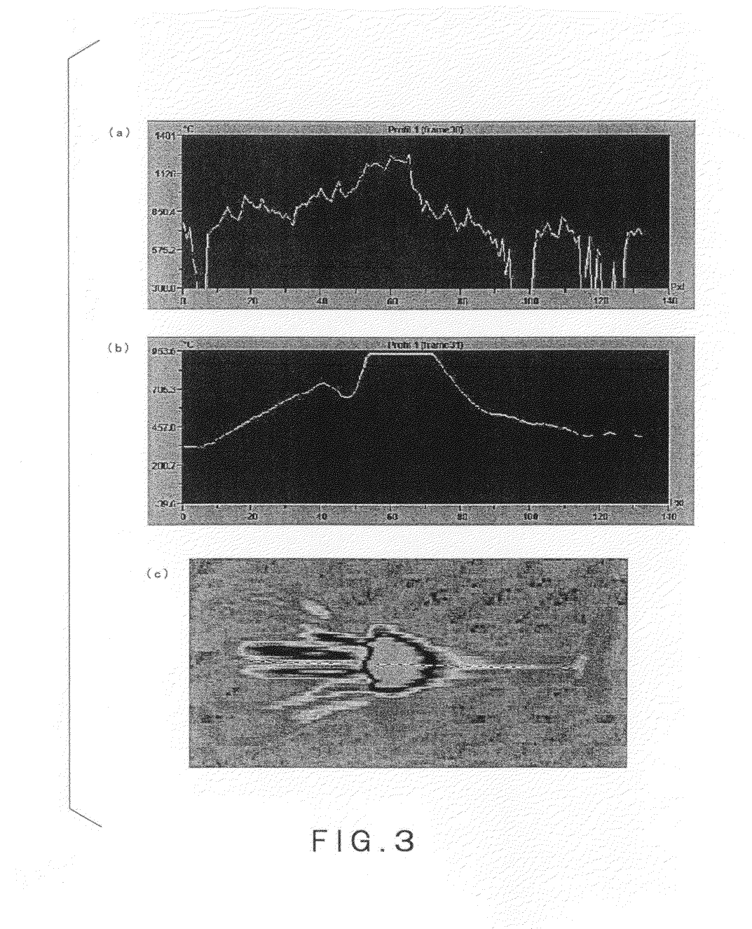

For example, temperature distribution of the flame F in each test was measured as shown in FIGS. 3(a) to 3(c). FIGS. 3(a) and 3(b) are charts respectively showing a temperature change of the flame F along a central line thereof, wherein each vertical axis designates an index of the temperature, while each horizontal axis designates a relative position from the main nozzle 5 imaginarily located on the left side in the drawings. More specifically, FIG. 3(a) shows measurement results in a higher temperature range, while FIG. 3(b) shows the measurement results in a lower temperature range. It is noted that some errors, due to a measurable range and displaying ability of a meter, etc., are shown in a relatively lower temperature range (i.e., portions lower than 200° C.) of FIG. 3(a). As is seen from the drawings, the temperature of the flame F is rapidly lowered from an initial higher temperature range (2500 to 1500° C.) to a temperature of 200° C. or lower, in the latter half of the total spray distance, i.e., in the vicinity of the base material M. Although the temperature around 200° C. is much lower than a melting point of an alloy used as the spray material, the spray material will be then attached onto the surface of the base material M so as to be solidified.

FIG. 3(c) shows an image of the whole body of the flame F taken by a thermal vision, wherein the main nozzle 5 is located on the left side in the drawing while the base material M is located on the right side. In this image, while partly blocked by the laterally extending external gas ejection nozzles 10, it can be seen that the higher temperature range of the flame F is considerably narrowed and shortened.

As used herein, the term “thermal vision” refers to an infrared camera (produced by NIPPON AVIONICS Co., Ltd., trade name: “COMPACT THERMO” (also referred to as “THERMO”)). Each measurement by the thermal vision was conducted, at (emissivity) of 0.10.

In the above test, a thermocouple was attached to the surface of each iron plate used as the base material M, (wherein, the thermocouple was inserted through a hole of the base material from its back and fixed in position in the vicinity of the surface thereof). Then, the temperature change of the base material M during the spray process was measured, with the spray gun and base material M being fixed in position, respectively. FIG. 4 shows a result of the measurement, demonstrating that the temperature of the base material M is not elevated above 350° C. This suppression of temperature rising of the base material M can be attributed to the fact that the flame F is cooled enough by the external gas H (i.e., the water mist in the example shown in FIG. 4).

FIG. 5 collectively shows results of measurements, obtained by the thermal vision, for the temperature distribution of the flame changed with pressure of air (and a flow rate thereof changed with the pressure), in the case in which the air (or external air) is ejected, as the external gas, toward the flame. In the drawing, each temperature history, from a position at a 100 mm spray distance to a position in which the flame reaches the base material M, is shown. Specifically, in the case (a) in which the air was not ejected, the temperature of the flame F was not lowered, but rather elevated, even in the latter half of the spray distance, for the reason that the flame F was partly returned after hit the base material M, or the like. However, in the cases (b) to (f), in which the pressure of the air was set at 0.1 to 0.5 MPa, respectively, as shown in the drawing, the temperature of the flame F was lowered before it reached the base material M.

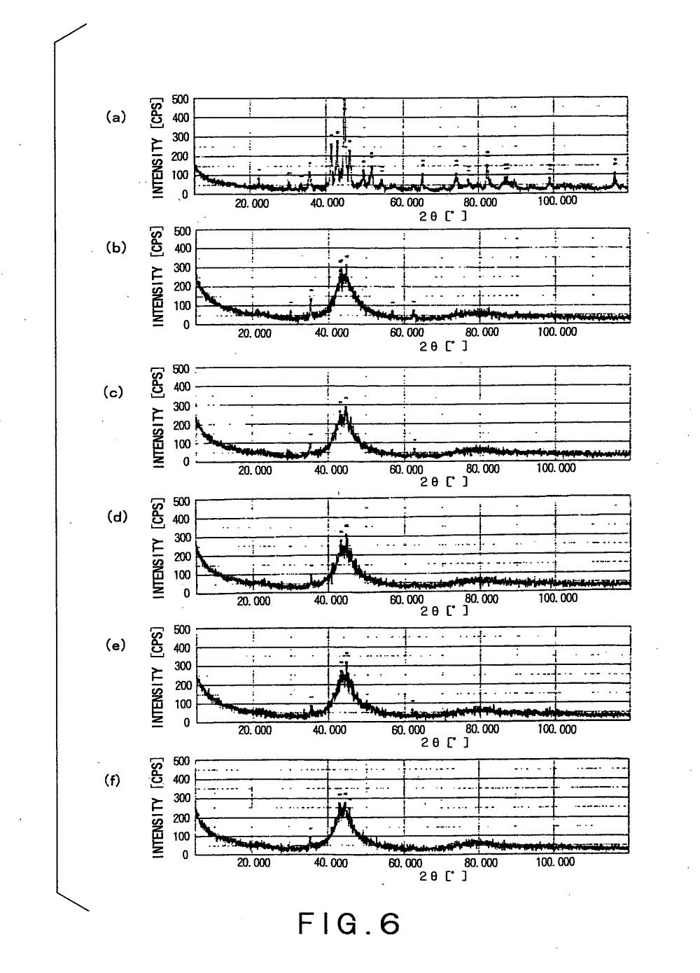

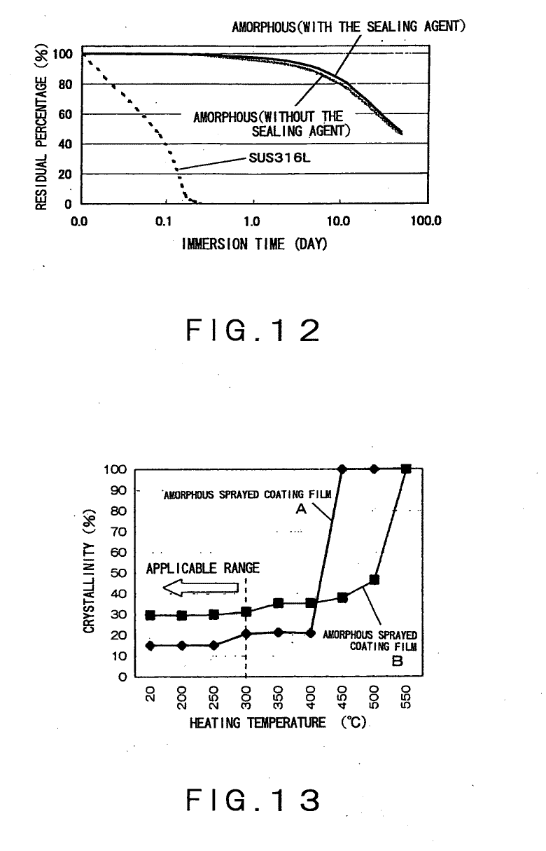

FIGS. 6(a) to 6(f) show results of X-ray diffraction measurements for the coating films each formed on the base material in the cases shown in FIGS. 5(a) to 5(f), respectively. In the drawings, the horizontal axis designates the diffraction angle 2θ, while the vertical axis designates intensity. In each of the cases (b) to (f), except for the case (a) in which the air was not ejected, a distinct halo peak, demonstrating that the coating film was mostly amorphous, could be seen. The crystallinity of the coating film in each of the cases (a) to (f) was 75.8%, 18.8%, 16.2%, 16.5%, 16.3% and 16.4%, respectively. Generally, each value of the crystallinity includes some deviation, depending on measurement conditions (including a meter, a measuring method and the like). Therefore, it is not adequate to consider such a value as an absolute criterion for assessing a degree of change into an amorphous state. However, in regard to each value obtained under the measurement conditions of this test (using equipment and analyzing software both produced by RIGAKU Co., Ltd., as will be described later), no crystal could be found, even in the case of using an optical microscope, if the measured crystallinity was lower than 20%. Thus, such a coating film can be considered to be changed into the amorphous state. Additionally, in regard to properties, the amorphous state measured in each case was proved by a result of an immersing test using aqua regia (see FIG. 12).

The meter and measurement conditions in the X-ray diffraction analysis (or XRD method) used for the test shown in FIGS. 5 and 6 were as follows.

Analyzer: RINT2000 (produced by RIGAKU Co., Ltd.)

Analysis conditions

Tube: Cu

Voltage: 40 kV

Electric current: 200 mA

Measuring angle (2θ): 5 to 120°

Scanning speed: 4°/min

The conditions (i.e., a kind, a supply amount and pressure of each supplied fuel gas) for the spray process and the like, common to each of the cases (a) to (f), were as follows.

Oxygen: 2.1 m³/h, 0.20 MPa

Acetylene: 1.8 m³/h, 0.10 to 0.12 MPa

Upon setting a reducing flame, the supply amount of the oxygen was controlled, such that the concentration of CO in the flame could be greater than 20% (v/v) when measured by the Orsat method.

A kind and a supply amount of each supplied metal powder were as follows.

Fe₇₀Cr₁₀P₁₃C₇ powder (containing 0.1 to 0.6 wt % of impurities other than Fe, Cr, P, C)

The particle size used: 38˜63 μm (about 50 g/min), 63 to 88 μm (about 160 g/min)

Ejection speed of the flame F: 30 to 140 m/sec

Highest temperature of the flame F: 1300° C. (measured by the THERMO).

The pressure of the external air, speed of the flame and average cooling speed of the flame, for each of the cases (a) to (f) shown in FIGS. 5 and 6, were as listed in the following Table 1.

TABLE 1

| | Pressure of the | Speed of the | Average cooling |
|---|---|---|---|
| Case | external air | flame | speed |
| (a) | No air | 30 m/sec | — |
| (b) | 0.1 MPa | 60 m/sec | 200,000 K/sec |
| (c) | 0.2 MPa | 80 m/sec | 850,000 K/sec |
| (d) | 0.3 MPa | 100 m/sec | 2,200,000 K/sec |
| (e) | 0.4 MPa | 120 m/sec | 3,000,000 K/sec |
| (f) | 0.5 MPa | 120 m/sec | 3,200,000 K/sec |

FIG. 7 shows a result of a measurement for the speed of the flame, in each case of changing the pressure of the external gas, in the same manner as in the cases shown in FIGS. 5 and 6. The speed was measured by an automatic current meter AV-80 type (produced by OKANO SEISAKUSHO Co., Ltd.) using a Pitot tube as a detector.

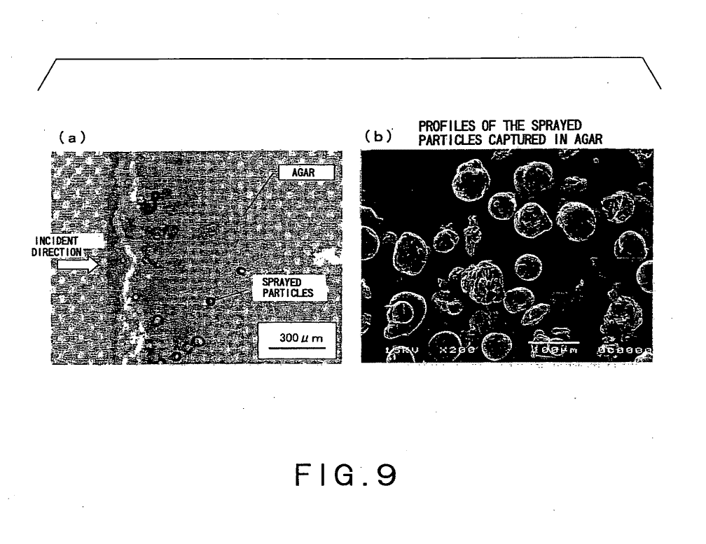

FIG. 8 is a chart showing a temperature change of the metal particles (each having the particle size of 38 μm or 63 μm) in the flame, in the case in which the pressure of the external air is set at 0.30 MPa. This temperature change was obtained by calculation in accordance with the Newton's cooling law, based on the temperature of the flame shown in FIG. 5 as well as on the speed of the flame shown in FIG. 7. As a result, it was found that a sufficient cooling speed, for changing the alloy of Fe₇₀—Cr₁₀—P₁₃—C₇ (each numerical value designates an atomic percentage (%), and this alloy contains impurities up to 0.6 wt %) into the amorphous state, could be obtained. Specifically, the cooling speed was 2,720,000K/sec in the case of the 38 μm particle size of the metal particles, while being 2,330,000K/sec in the case of the 63 μm particle size of the metal particles. The fact that the particle size of the metal particles in the flame was substantially equal to the particle size of the powder used as a raw material for the spray process was confirmed by a test as illustrated in FIG. 9. In this test, the metal particles were sprayed toward agar located in a position at a 200 mm distance from the ejection port and captured therein.

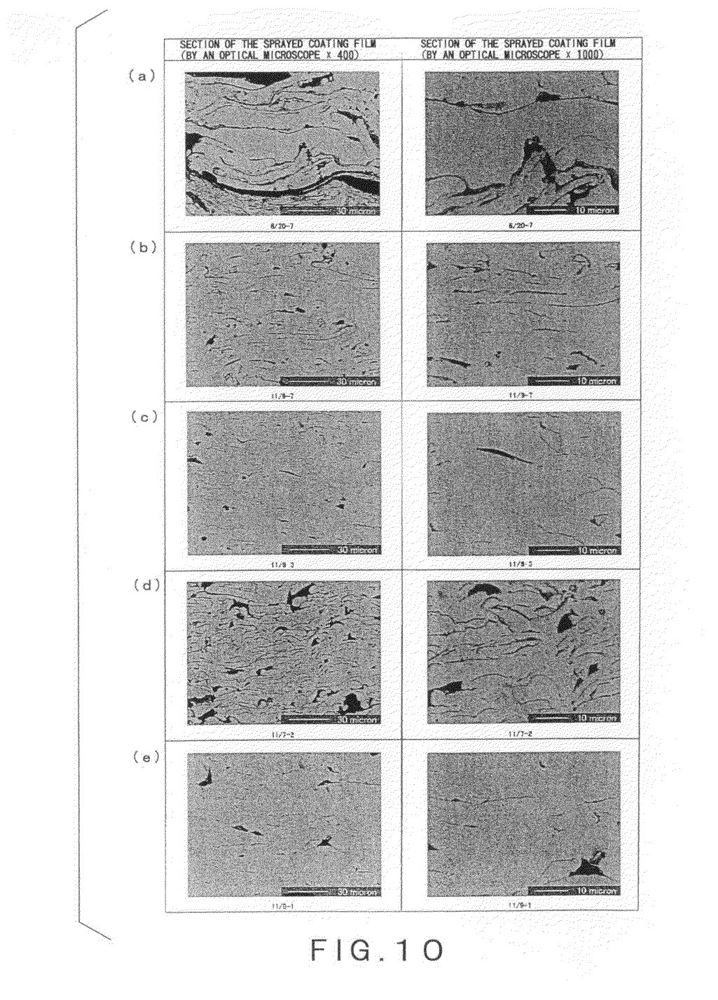

FIGS. 10(a) to 10(e) show microphotographs (left: ×400, right: ×1000) and results of the X-ray diffraction measurements for sections of the sprayed coating films, respectively. These photographs and results were obtained in the respective cases of changing components of the flame, internal cooling and external cooling gases and diameter of the powder material (or particle size of the metal particles), as shown in Table 2.

In FIGS. 10, although voids characteristic specific to the case of spraying can be seen, it can be observed that the amorphous coating film containing no crystals is formed. Although the kind, amount and pressure of each fuel gas supplied, kind of each metal powder, ejection speed and highest temperature of the flame F and ejection amount of the air G (or internal gas) were substantially the same as those shown in FIGS. 5 and 6, the conditions shown in Table 2 were changed, respectively.

TABLE 2

| | | Internal | External | Pressure of | Diameter of |
|---|---|---|---|---|---|
| | Burning | cooling | cooling | the external | the metal |
| Case | flame | gas | gas | cooling gas | particles |
| (a) | Normal | Air | Air | 0.3 MPa | 38 to 63 μm |
| | flame | | | | |
| (b) | Reducing | Air | Air | 0.3 MPa | 38 to 63 μm |
| | flame | | | | |
| (c) | Reducing | Nitrogen | Nitrogen | 0.15 MPa | 38 to 63 μm |
| | flame | | | | |
| (d) | Reducing | Nitrogen | Nitrogen | 0.15 MPa | Less than |
| | flame | | | | 38 μm |
| (e) | Reducing | Nitrogen | Nitrogen | 0.15 MPa | 63 to 88 μm |
| | flame | | | | |

Referring to FIGS. 10, many stripes due to oxides were observed in the case (a) in which the spray process was conducted, using the normal flame (containing a theoretical amount of oxygen) as well as using air as both of the internal cooling gas and external cooling gas. However, in the cases (b) to (e) in which the spray process was conducted, using the reducing flame (containing 20 to 30% (v/v) of CO) as well as using nitrogen as both of the internal cooling gas and external cooling gas, stripes were conspicuously reduced. Especially, in the cases (c) and (e), such oxides were significantly reduced.

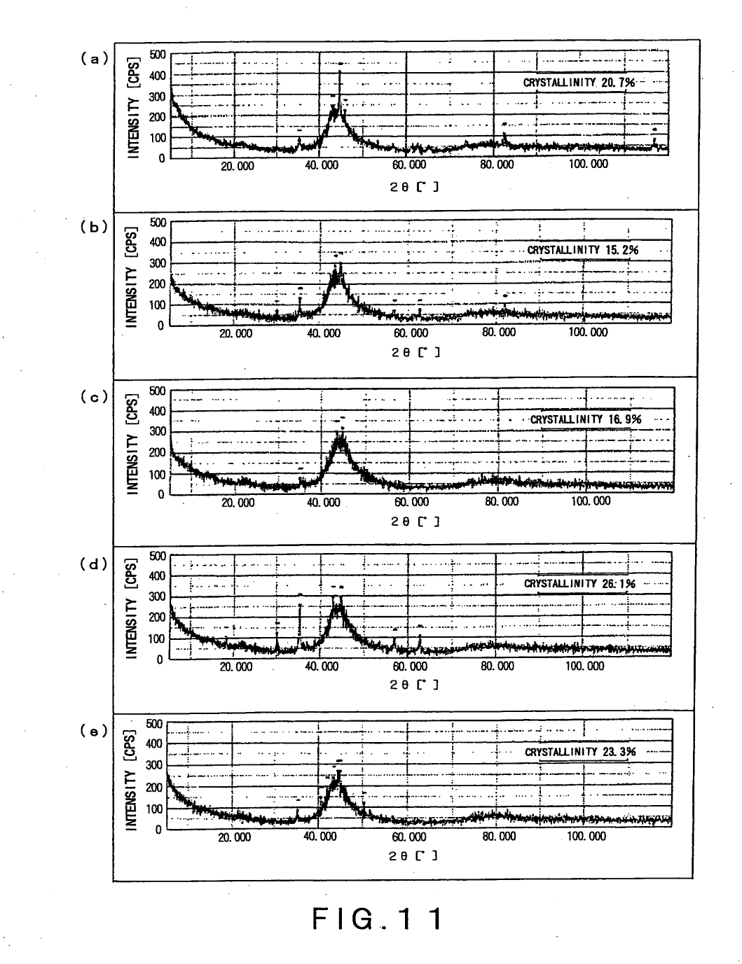

FIGS. 11(a) to 11(e) respectively show results of the X-ray diffraction measurements for the coating films respectively formed on the base material in the cases shown in FIGS. 10(a) to 10(e). In these drawings, the horizontal axis designates the diffraction angle 2θ, and the vertical axis designates intensity. In this test, the meter and measurement conditions were respectively the same as those employed in the test shown in FIGS. 6. In either case shown in FIGS. 11(a) to 11(e), a distinct halo peak and relatively low crystallinity were observed. Namely, it was found that the raw material was mostly changed into the amorphous state.

FIG. 12 shows a result of a corrosion-resistance test for the sprayed coating films (amorphous coating films) respectively formed on the base material in the case (c) shown in FIGS. 10 and 11. In this test, the coating films coated with/without a sealing agent, and SUS316L stainless steel (a bulk material having been subjected to a blasting process) were used as samples and continuously immersed into aqua regia (a mixture of hydrochloric acid and nitric acid), respectively. As a result, the SUS316L stainless steel was completely dissolved within approximately 6 hours, while a corrosion rate in the coating film was extremely slow, resulting in only 1.2% progress per day.

FIG. 13 shows a result of a heat-resistance test on two kinds of coating films (amorphous sprayed coating films A and B) respectively obtained in the same manner as described above. In this test, the crystallinity of each coating film was measured after the coating film was kept in the air at each temperature. As is seen from the drawing, the coating film formed by the spray method of this embodiment is preferably used below 300° C., in order to keep a stable amorphous state of the coating film.

While the spray process for the Fe₇₀Cr₁₀P₁₃C₇ alloy (containing impurities up to 0.6 wt %) having a relatively high melting point (1500° C. or higher) has been discussed above, the spray apparatus 1 can also be applied to the case of forming an amorphous metal on the base material, with another iron-chromium-type alloy or any other suitable alloy than the Fe₇₀Cr₁₀P₁₃C₇ alloy.

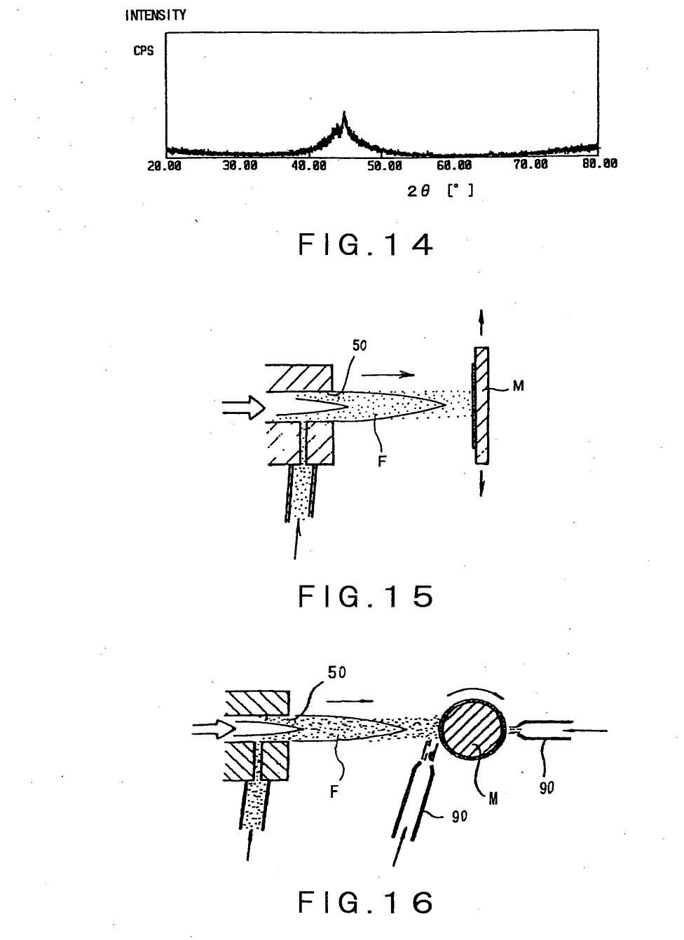

For instance, the spray apparatus 1 can also be used for forming another amorphous coating film on the base material, by using the Fe₈₁B₁₃Si₄C₂ alloy that is generally known to have excellent magnetic properties and/or Fe(r1)-B(r2)-Si(r3)-C(r4)-type alloy containing similar chemical components to the Fe₈₁B₁₃Si₄C₂ alloy. In this Fe(r1)-B(r2)-Si(r3)-C(r4)-type alloy, each ri of r1 to r4 designates an atomic percentage (%) and satisfies 2<r1<85, 11<r2<16, 3<r3<12, 1<r4<72. Again, the alloy of this type can be applied to the formation of the amorphous coating film on the surface of the base material, even though the alloy contains 0.6 wt % or less of impurities. FIG. 14 shows a result of the X-ray diffraction measurements for the coating film of the Fe₈₁B₁₃Si₄C₂ alloy actually formed by an experiment, and data related to the formation of the coating film are listed in the following Table 3.

TABLE 3

| | |
|---|---|
| Powder material | Fe₈₁B₁₃Si₄C₂ powder (atomic percentage (%)) |
| used | This powder contains impurities, such as |
| | Mn, P and the like, other than Fe, B, Si, |
| | C, within 0.6 wt %. |
| Particle size or | Particle size: 38 to 63 μm |
| the like factor of | Amount of the powder used: About |
| the powder | 50 g/min |
| External cooling | 0.15 MPa Nitrogen |
| gas | |

The meter and measurement conditions used for the X-ray diffraction analysis (or XRD method) were as follows.

Analyzer: RU-200B type (produced by RIGAKU Co., Ltd.)

Analysis conditions

Tube: Cu

Voltage: 40 kV

Electric current: 200 mA

Measuring range: 20 to 80°

Scanning speed: 4°/min

It is noted that a means for forming the amorphous coating film is not limited to the spray apparatus 1 used in the above examples. For instance, with respect to the ejection nozzles 10 (see FIG. 1) used for the external cooling, the position and/or orientation of each nozzle may be set in a different manner than that shown in the drawings. Additionally, the ejection nozzles 10 may be provided to spray the water mist or the like, radially, with some spreading angle, from points along a particular circle surrounding the main nozzle 5. As the fuel other than acetylene, propane and/or carbon monoxide (CO), hydrogen (H₂) or the like may be used. While the spray apparatus 1 has been discussed above as the so-called flame-type one, this spray apparatus 1 may also be configured as a High Velocity Oxy-Fuel-type, arc-type, or plasma-type spray apparatus. In the case of the arc-type spray apparatus, it is preferred that a part of the arc can be cooled. Similarly, in the case of the plasma-type spray apparatus, it is preferred that a part of the plasma jet can be cooled. Furthermore, a linear material may be used in place of the powder material. In this case, the linear material is preferably selected such that the particle size of the melted metal particles thereof in the flame will be within a proper range as described above.

While several preferred examples have been discussed, in particular to some extent, it will be obvious to those skilled in the art that various modifications and alterations can be made thereto. Accordingly, it should be construed that the present invention can be embodied in different aspects than those particularly described and shown herein, without departing from the scope and spirit of the appended claims.

1. A method of forming an amorphous coating film, the method comprising the steps of: ejecting a flame containing material particles toward a base material from a nozzle, such that the material particles are melted with the flame; and cooling the material particles and the flame before they reach the base material.

2. The method of forming the amorphous coating film according to claim 1, wherein the step of cooling the material particles and the flame is performed by ejecting a cooling fluid toward the flame.

3. The method of forming the amorphous coating film according to claim 2, wherein the cooling fluid is a gas or a gas mixed with a liquid mist.

4. The method of forming the amorphous coating film according to claim 3, wherein the cooling fluid contains an inert gas.

5. The method of forming the amorphous coating film according to claim 2, wherein the cooling fluid is externally ejected toward the flame, in the step of cooling the material particles and the flame.

6. The method of forming the amorphous coating film according to claim 5,
wherein the nozzle is a nozzle of a spray gun, the spray gun including a gas ejection cylinder provided around the nozzle, the gas ejection cylinder being configured to eject a cooling gas for cooling a gun main body, and
wherein the cooling gas is ejected from the gas ejection cylinder toward the flame in order to cool the flame, in addition to the cooling fluid externally ejected toward the flame, in the step of cooling the material particles and the flame.

7. The method of forming the amorphous coating film according to claim 6, wherein the cooling gas is an inert gas.

8. The method of forming the amorphous coating film according to claim 2, wherein the base material is also cooled, together with the material particles and the flame, by the cooling fluid ejected toward the flame, in the step of cooling the material particles and the flame, whereby a temperature of the base material can be controlled within a range of 50° C. to 350° C., while the base material is not cooled by any other cooling means than the cooling fluid.

9. The method of forming the amorphous coating film according to claim 2, wherein the cooling fluid is ejected toward the flame from a plurality of points positioned around the flame.

10. The method of forming the amorphous coating film according to claim 2, wherein the cooling fluid is obliquely ejected from the nozzle toward a central line of the flame, such that the cooling fluid gradually approaches the central line of the flame as the cooling fluid travels from an upstream side to a downstream side along an ejection direction of the flame.

11. The method of forming the amorphous coating film according to claim 2, wherein a speed of the material particles in the flame is accelerated by ejecting the cooling fluid toward the flame.

12. The method of forming the amorphous coating film according to claim 1, wherein the material particles are melted within 5/1000 seconds after ejected from the nozzle, then cooled within 2/1000 seconds at a cooling speed within a range of 10,000K/sec to 1,000,000K/sec.

13. The method of forming the amorphous coating film according to claim 1, wherein a particle size (R) of the material particles is expressed by a following expression:
R=(6U)/{ρ·C·(v/v0)1/2}(cm),
wherein U designates an amount of heat per unit surface area and is expressed as follows:
U=(the amount of heat (cal/° C.) of the material particle)/(a surface area of the material particle (cm2))=C·ρ·V/A (cal/cm2° C.),
0.196/1000≦U≦1.96/1000, and
wherein V is a volume (cm3) of the material particle, A is the surface area (cm2) of the material particle, ρ is a specific gravity (g/cm3) of the material, C is a specific heat (cal/g° C.) of the material, v is a speed (cm/sec) of the material particle when it is ejected, and v0 is a standard material-particle speed (6000 cm/sec).

14. The method of forming the amorphous coating film according to claim 13, wherein the particle size of the material particles is within a range of 10 μm to 100 μm, in a case in which the standard material-particle speed is approximately 6000 cm/sec.

15. The method of forming the amorphous coating film according to claim 1, wherein a reducing flame containing 20 to 30% by volume of CO, while containing oxygen less than a theoretical amount of the oxygen contained in a normal flame, is used as the flame.

16. The method of forming the amorphous coating film according to claim 1, wherein a material used for general industrial purposes and containing impurities within a range of 0.1% to 0.6% is used as the material particles.

17. The method of forming the amorphous coating film according to claim 16, wherein the spray gun including the nozzle is used in the air for spraying the material particles onto a surface of the base material, while a rear face and an interior of the base material is not cooled.

18. The method of forming the amorphous coating film according to claim 1,
wherein a Fe(r1)-Cr(r2)-P(r3)-C(r4)-impurity type material is used as the material particles, for forming the amorphous coating film of an iron-chromium type alloy,
wherein each ri of r1 to r4 designates an atomic percentage (%), and satisfies a following expression:
Σri=r1+r2+r3+r4≈100, in which
65<r1<75, 4<r2<15, 8<r3<17, 1<r4<8, and
wherein a content of impurities is within a range of 0.1 to 0.6 wt %.

19. The method of forming the amorphous coating film according to claim 18, wherein r1, r2, r3, r4 are 70, 10, 13, 7, respectively.

20. The method of forming the amorphous coating film according to claim 19, wherein a particle size of the material particles is within a range of 38 μm to 63 μm.

21. The method of forming the amorphous coating film according to claim 1,
wherein a Fe(r1)-B(r2)-Si(r3)-C(r4)-impurity type material is used as the material particles, for forming the amorphous coating film of a magnetic alloy,
wherein each ri of r1 to r4 designates an atomic percentage (%), and satisfies a following expression:
Σri=r1+r2+r3+r4≈100, in which
2<r1<85, 11<r2<16, 3<r3<12, 1<r4<72, and
wherein a content of impurities is 0.6 wt % or less.

22. The method of forming the amorphous coating film according to claim 21, wherein r1, r2, r3, r4 are 81, 13, 4, 2, respectively.

23. An apparatus for forming an amorphous coating film by spraying, the apparatus comprising:
a spray gun configured to eject a flame containing material particles toward a base material, such that the material particles are melted with the flame, the spray gun including a flame ejection nozzle for ejecting the flame and a gas ejection cylinder provided around the flame ejection nozzle and configured to eject a cooling gas for cooling a gun main body; and
a cooling mechanism configured to cool the material particles and the flame ejected from the flame ejection nozzle before they reach the base material, the cooling mechanism including a cooling fluid ejection nozzle configured to externally eject a cooling fluid toward the flame.

24. The apparatus for forming the amorphous coating film according to claim 23, wherein the cooling fluid ejection nozzle includes a plurality of nozzles respectively located in a circumferential direction about the flame.

25. The apparatus for forming the amorphous coating film according to claim 23, wherein the cooling fluid ejection nozzle is configured to obliquely eject the cooling fluid toward a central line of the flame, such that the cooling fluid gradually approaches the central line of the flame as the cooling fluid travels from an upstream side to a downstream side along an ejection direction of the flame.

26. The apparatus for forming the amorphous coating film according to claim 23, wherein the cooling fluid ejection nozzle is configured to eject the cooling fluid, such that a speed of the material particles in the flame is accelerated by ejecting the cooling fluid toward the flame.
